(19) United States
(12) Patent Application Publication
(10) Pub. No.: US 2023/0139014 A1
(43) Pub. Date: May 4, 2023

(54) AIRCRAFT PRESSURE PANEL ASSEMBLIES

(71) Applicant: The Boeing Company, Chicago, IL (US)

(72) Inventors: Adriana Willempje Blom-Schieber, Snohomish, WA (US); Patricia Winifred Estell, Woodinville, WA (US)

(21) Appl. No.: 17/513,626

(22) Filed: Oct. 28, 2021

(51) Int. Cl. B64C 1/00

(52) U.S. Cl. CPC B64C 1/00; B64C 2001/009

(57) ABSTRACT

Pressure panel assemblies have a high-pressure side and a low-pressure side and comprise panels, one or more splicing members, and one or more beams. The panels comprise a first panel and a second panel that is positioned laterally adjacent to the first panel. Each of the first panel and the second panel have a longitudinal panel length. A first splicing member is welded to the first panel and to the second panel along the longitudinal panel length of the first and second panels. A first beam is joined directly to the first splicing member or is joined directly to the first panel and to the second panel.

### FIELD

The present disclosure relates to aircraft pressure panel assemblies.

### BACKGROUND

Aircraft are generally designed to operate in low ambient atmospheric pressure while maintaining a pressurized compartment for passengers, operators, and/or cargo. Pressure panels are used to isolate and maintain different pressurized regions within an aircraft, such as, for example, a pressurized passenger compartment and an unpressurized mechanical compartment.

Aircraft also incorporate load-bearing supports that react to loads by flexing. For example, wings of an aircraft in flight bear the load of the aircraft and any cargo. Where a wing of an aircraft interacts with pressure panels within the fuselage, the pressure panels coupled to the wing take on the deflected shape of the wing, which generates significant forces in the adjacent pressure panels. Historically, these adjacent pressure panels are sized to react to these wing deflection induced forces, resulting in pressure panels that are heavy.

### SUMMARY

Aircraft pressure panel assemblies, aircraft comprising the same, and methods of assembling the same are disclosed herein. The pressure panel assemblies have a high-pressure side and a low-pressure side opposite the high-pressure side and comprise panels, one or more splicing members, and one or more beams. The panels comprise at least a first panel and a second panel that is positioned laterally adjacent to the first panel. Each of the first panel and the second panel have a longitudinal panel length. The one or more splicing members comprise at least a first splicing member that is welded to the first panel and to the second panel along the longitudinal panel length of the first panel and the second panel. The one or more beams comprise at least a first beam that is joined directly to the first splicing member or that is joined directly to the first panel and to the second panel. The first splicing member extends along the longitudinal panel length on the high-pressure side of the first splicing member or on the high-pressure side of the first panel and of the second panel. Aircraft comprise a fuselage with a pressurized compartment and the pressure panel assembly supported by the fuselage, and with the high-pressure side facing the pressurized compartment and the low-pressure side facing away from the pressurized compartment.

### BRIEF DESCRIPTION OF THE DRAWINGS

FIG. 1 is a perspective view of an example aircraft.

FIG. 2 is a schematic diagram representing pressure panel assemblies according to the present disclosure.

FIG. 3 is a schematic perspective view of an example pressure panel assembly according to the present disclosure.

FIG. 4 is a schematic perspective view of another example pressure panel assembly according to the present disclosure.

FIG. 5 is a schematic perspective view of another example pressure panel assembly according to the present disclosure.

FIG. 6 is a schematic perspective view of another example pressure panel assembly according to the present disclosure.

FIG. 7 is a flow chart schematically representing example methods according to the present disclosure.

### DESCRIPTION

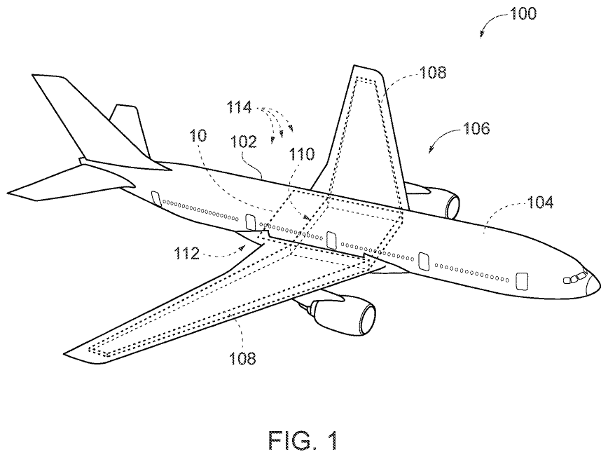

FIG. 1 schematically presents a commercial fixed-wing aircraft 100, as an illustrative, non-exclusive example of an application that may utilize pressure panel assemblies 10 according to the present disclosure. However, other aerospace applications are within the scope of the present disclosure, including (but not limited to) military aircraft, rotorcraft, and space vehicles. Moreover, pressure panel assemblies 10 according to the present disclosure also may be used in non-aerospace applications to define pressure barriers, for example, including (but not limited to) marine applications, such as in submarines.

Aircraft 100 may include one or more pressurized compartments 104 for such purposes as comfort of operators and passengers, and for protection of cargo and equipment. Aircraft 100 typically include pressure panels 114, sometimes referred to as pressure decks, to isolate and maintain the integrity of pressurized compartments 104 within the aircraft 100. The pressure panels 114 are subject to the pressure differential of the pressurized compartment 104 relative to neighboring compartments and/or ambient conditions. Further, the pressure panels 114 may be subject to loads and/or deformation transmitted by other components of the aircraft 100. Such loads and/or deformation may have their ultimate source in the weight and the lift of the aircraft 100.

Aircraft 100 that include pressurized compartments 104 also may include unpressurized compartments, such as mechanical compartments for equipment that requires no pressurization. Pressure panels 114 are used to separate pressurized and unpressurized compartments. One type of unpressurized compartment is a wheel well 112. On some aircraft, the wheel well 112 is located near where the wing assembly 106 meets the fuselage 102. The wheel well 112 may be adjacent or under the fuselage 102 and/or may be defined by the fuselage 102, and may be under and/or aft of the wing assembly 106. Other configurations also are within the scope of aircraft 100 according to the present disclosure.

Additionally or alternatively, in some aircraft, compartments may not be actively pressurized by a pressurization system, yet compartment walls may still be subject to pressure differentials during flight, simply due to the change in altitude and/or forces of flight, and thus external air pressure may be greater or less than an internal pressure of the compartment. For example, some aircraft do not include active pressurization systems to maintain an elevated pressure within a compartment, e.g., a cargo compartment, yet pressure differentials, including positive and/or negative pressure differentials, may be imparted between the exterior of a compartment and the interior of a compartment during flight.

The wing assembly 106 of an aircraft 100 typically includes two wing outboard sections 108 and a wing center section 110 between the wing outboard sections 108. The wing center section 110 may pass through or under the fuselage 102. In flight, the wing assembly 106 creates lift, which counteracts the weight of the aircraft 100. Because the lift is distributed along the wing outboard sections 108, the wing assembly 106 is subject to stress. Under the stress of flight, the wing assembly 106 bends, subjecting the upper portion of the wing assembly 106 to compression and the lower portion of the wing assembly 106 to tension. Components closely coupled to the wing assembly 106 are thus deformed under the displacement imposed by the wing assembly 106 during flight. For example, where the wheel well 112 is adjacent to the wing assembly 106, a portion of the wheel well 112 may be compressed with the upper portion of the wing center section 110 of the wing assembly 106. When a pressure panel 114 is used to form a portion of such a wheel well 112, sometimes referred to as a horizontal pressure deck, the pressure panel 114 may be subject to the displacement of the wing assembly 106, and thus subject to compression as well as the pressure differential between the wheel well 112 and the pressurized compartment 104.

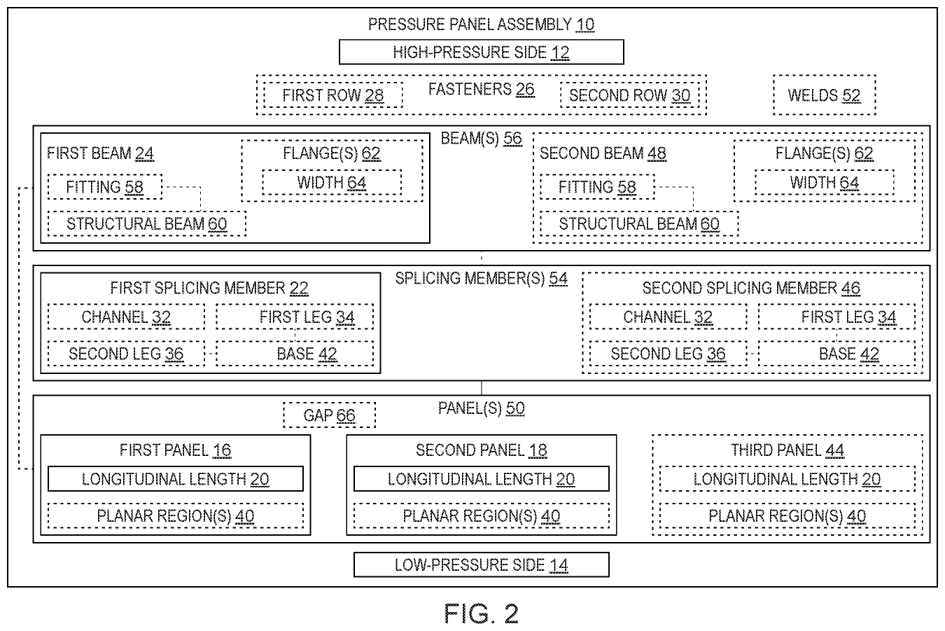

Turning to FIG. 2, pressure panel assemblies 10, which may form or be a component of a pressure panel 114 of an aircraft 100, are schematically represented. Generally, in FIG. 2, elements that are likely to be included in a given example are illustrated in solid lines, while elements that are optional to a given example or that correspond to an optional or alternative embodiment are illustrated in broken lines. However, elements that are illustrated in solid lines are not essential to all examples of the present disclosure, and an element shown in solid lines may be omitted from a particular example without departing from the scope of the present disclosure.

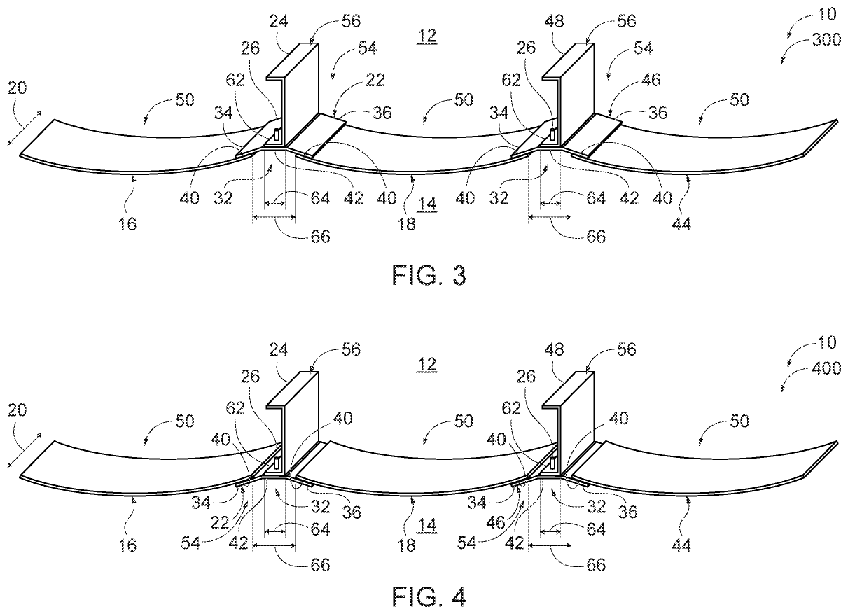

FIGS. 3-6 illustrate examples of pressure panel assemblies 10, identified as pressure panel assemblies 300, 400, 500, and 600, respectively. Where appropriate, the reference numerals from the schematic illustration of FIG. 2. are used to designate corresponding parts of the examples of FIGS. 3-6; however, the examples of FIGS. 3-6 are non-exclusive and do not limit pressure panel assemblies 10 to the illustrated embodiments of FIGS. 3-6. That is, pressure panel assemblies 10 may incorporate any number of the various aspects, configurations, characteristics, properties, etc. of pressure panel assemblies 10 that are illustrated in and discussed with reference to the schematic representation of FIG. 2 and/or the embodiments of FIGS. 3-6, as well as variations thereof, without requiring the inclusion of all such aspects, configurations, characteristics, properties, etc.

With reference to FIG. 2, pressure panel assemblies 10 may be described as having a high-pressure side 12 and a low-pressure side 14 that is opposite the high-pressure side 12. That is, pressure panel assemblies 10 are intended to be installed in a specific orientation, with the high-pressure side 12 facing a relatively higher pressure environment, such as a pressurized compartment 104 of an aircraft 100, and with the low-pressure side 14 facing a relatively lower pressure environment, such as an unpressurized compartment of the aircraft 100. As schematically represented in FIG. 2, and as illustrated in the examples of FIGS. 3-6, pressure panel assemblies 10 comprise panels 50, one or more splicing members 54 comprising at least a first splicing member 22, and one or more beams 56 comprising at least a first beam 24. The panels 50 comprise pairs of laterally adjacent panels 50, including at least a first panel 16 and a second panel 18, with the second panel 18 positioned laterally adjacent to the first panel 16. Each of the panels 50 have a longitudinal panel length 20 that typically corresponds to an overall length of the pressure panel assembly 10 itself. By “laterally adjacent” to each other, it is meant that the panels 50 are positioned side-by-side with respect to their widths that are transverse to the longitudinal panel length 20, as opposed to being positioned end-to-end along their longitudinal panel length 20. Moreover, pressure panel assemblies 10 may include any suitable number of panels 50, including three or more panels 50, that are positioned laterally adjacent, or side-by-side, to each other, depending on the specific size of pressure panel assembly 10. FIG. 2 schematically illustrates, and the examples of FIGS. 3-6 further comprise, an optional third panel 44 positioned laterally adjacent to the second panel 18 opposite the first panel 16; however, more than three panels 50 may be included in a pressure panel assembly 10. The panels 50 of pressure panel assemblies 10 additionally or alternatively may be described as webs of the pressure panel assemblies 10.

Each splicing member 54 is welded to a pair of laterally adjacent panels 50 along the longitudinal panel length 20. That is, the first splicing member 22 is welded to the first panel 16 and to the second panel 18 along the longitudinal panel length 20. When a third panel 44 is included, a second splicing member 46 is welded to the second panel 18 and to the third panel 44 along the longitudinal panel length 20, and so forth depending on the number of panels 50 in a particular pressure panel assembly 10. Additionally or alternatively, as schematically represented in FIG. 2, pressure panel assemblies 10 may be described as comprising welds 52 between a splicing member 54 and each of the two corresponding laterally adjacent panels 50. Because the welds 52 run the full longitudinal panel length 20, the welds 52 form an air-tight seal between the splicing member 54 and the respective panels 50 to prevent air from passing from the high-pressure side 12 to the low-pressure side 14 of the pressure panel assembly 10. Accordingly, some examples of pressure panel assemblies 10 are free of fay seals between panels 50 and corresponding splicing members 54. In some such examples, the pressure panel assemblies 10 also are free of fasteners that couple together the panels 50 and corresponding splicing members 54. Moreover, the welds 52 will carry the load associated with any displacement, compression, shear, and/or tension experienced by the pressure panel assembly 10 during operation. For example, when a pressure panel assembly 10 is utilized as a horizontal pressure deck aligned with or adjacent to the upper surface of the wing center section 110 of an aircraft 100, the compressive forces experienced by the horizontal pressure deck during flight will be carried by the welds 52. In addition, the pressure differential across the pressure panel assembly 10 tends to flex the pressure panel assembly 10 towards its low-pressure side 14 which results in loads carried by the welds 52.

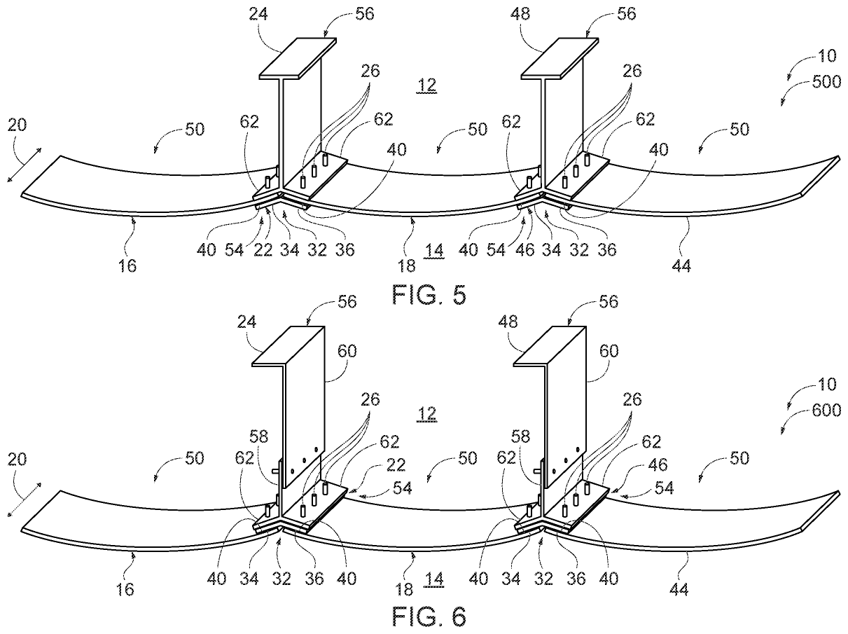

In some examples of pressure panel assemblies 10, a beam 56 is joined directly to a corresponding splicing member 54, such as in the example pressure panel assemblies 300, 400, and 600 of FIGS. 3, 4, and 6. In other examples of pressure panel assemblies 10, a beam 56 is joined directly to two laterally adjacent panels 50, such as in the example pressure panel assembly 500 of FIG. 5. In either case, the beam 56 extends along the longitudinal panel length 20 on the high-pressure side 12 of the splicing member 54 or on the high-pressure side 12 of the respective panels 50. A beam 56 of a pressure panel assembly 10 additionally or alternatively may be described as a beam assembly 56 and may include more than one structural component, such as a fitting 58 that is joined directly to either a splicing member 54 or to two laterally adjacent panels 50, and a separate structural beam 60 that is joined directly to the fitting 58, such as in example pressure panel assembly 600 of FIG. 6. By two components being “joined directly” together, it is meant that a distinct structural component is not positioned between the respective components; however, it is within the scope of being “joined directly” that an adhesive, a sealant, a gasket, or other non-structural component is positioned between the two components that are “joined directly” together. “Joined directly” is distinguished from being “coupled indirectly.” For example, with respect to pressure panel assemblies 300, 400, and 600 of FIGS. 3, 4, and 6, the beams 56 are joined directly to the respective splicing members 54 and are coupled indirectly to the panels 50 via the splicing members 54. With respect to pressure panel assembly 500 of FIG. 5, the beams 56 are joined directly to corresponding panels 50 and are coupled indirectly to corresponding splicing members 54 via the panels 50.

One or more of the panels 50, the splicing member(s) 54, and the beam(s) 56 (or at least fitting(s) 58 of the beam(s) 56) may be constructed of a thermoplastic material, such as a fiber reinforced thermoplastic material. The thermoplastic materials of the panels 50, the splicing member(s) 54, and the beam(s) 56 need not be identical when more than one are constructed of a thermoplastic material, but when two such components are welded together, such as the panels 50 and the splicing member(s) 54, the thermoplastic materials are selected to result in a structurally sound weld having the desired properties for carrying the loads experienced by the pressure panel assembly 10 during operative use. Examples of suitable thermoplastics include (but are not limited to) polyphenylene sulfide (PPS) and polyaryletherketone (PAEK), such as polyether ether ketone (PEEK) and polyetherketoneketone (PEKK). Examples of suitable fibers include (but are not limited to) carbon fibers, glass fibers, and aramid fibers.

Alternatively, one or more of the panels 50, the splicing member(s) 54, and the beam(s) 56 (or at least fitting(s) 58 of the beam(s) 56) may be constructed of a metallic material, such as an aluminum alloy or a titanium alloy, a fiber-reinforced thermoset material, and/or a combination of one or more of a thermoplastic material, a metallic material, and a fiber-reinforced thermoset material.

In some examples in which both the splicing member(s) 54 and the beam(s) 56 (or at least fitting(s) 58 thereof) are constructed of a thermoplastic material, the beam(s) 56 are welded to corresponding splicing member(s) 54 along the longitudinal panel length 20, such as in the example pressure panel assemblies 300, 400, and 600 of FIGS. 3, 4, and 6. In other such examples in which both the panels 50 and the beam(s) 56 (or at least fitting(s) 58 thereof) are constructed of a thermoplastic material, the beam(s) 56 are welded to the corresponding laterally adjacent panels 50, such as in the example pressure panel assembly 500 of FIG. 5.

In some examples, the beam(s) 56 are fastened to at least the splicing member(s) 54 with a plurality of fasteners 26. Fasteners 26 additionally or alternatively may be described as mechanical fasteners 26 (e.g., bolts and nuts, rivets, lock bolts, etc.), and as used herein “fasteners” does not comprise welds. In some such examples, the beam(s) 56 are fastened to both the splicing member(s) 54 and corresponding laterally adjacent panels 50. For example, as in example pressure panel assembly 500 of FIG. 5, laterally adjacent panels 50 are positioned and compressed between the corresponding splicing members 54 and beams 56. In other examples, as in example pressure panel assembly 600 of FIG. 6, the splicing members 54 are positioned and compressed between the beams 56 and the corresponding laterally adjacent panels 50. In examples such as pressure panel assembly 500 and pressure panel assembly 600, in which a splicing member 54, a beam 56, and corresponding laterally adjacent panels 50 are all three coupled together, the load transfer though two interfaces, rather than just one, as in the examples of FIGS. 3 and 4, results in a lighter weight joint with a higher load capability.

In some examples, as in example pressure panel assemblies 500 and 600 of FIGS. 5 and 6, the beam(s) 56 are fastened to the splicing member(s) 54 and a corresponding one of a pair of laterally adjacent panels 50 utilizing a first single row 28 of the fasteners 26, and the beam(s) 56 are fastened to the splicing member(s) 54 and a corresponding other one of the pair of laterally adjacent panels 50 utilizing a second single row 30 of the fasteners 26. In particular, in such examples where the panels 50 are welded to the splicing member(s) 54, as well as in such examples where the splicing member(s) 54 are welded to the beam(s) 56, because the corresponding welds 52 serve to carry loads experienced by the pressure panel assembly 10, fewer fasteners may be needed to adequately secure the beam(s) 56 to the splicing member(s) 54 and/or the panels 50. In other examples, more than one row of fasteners may be utilized.

Each of the panels 50 may be described as having a cross-sectional shape that is generally uniform along the longitudinal panel length 20. By “generally uniform,” it is meant that the cross-sectional shape may not be perfectly uniform along the full length of the panel 50, and that slight variations may be present, such as to due to inclusion of one or more of doublers, padups, fastener holes, and the like. In some examples of pressure panel assemblies 10, the cross-sectional shape is concave toward the high-pressure side 12, such as in the example pressure panel assemblies 300, 400, 500, and 600 of FIGS. 3-6. As more particular examples, the cross-section shape may be substantially curved, substantially arced, substantially parabolic, or substantially catenary in shape. By being “substantially curved,” “substantially arced,” “substantially parabolic,” or “substantially catenary,” it is meant that at least 75% of the length of the cross-sectional shape has the identified shape (i.e., curved, parabolic, or catenary). For example, as discussed herein, some examples of panels 50 comprise one or more planar regions 40 where the panels 50 are welded to corresponding splicing members 54, with such planar regions 40 necessarily not having a curved, parabolic, or catenary cross-sectional shape.

In some examples of pressure panel assemblies 10, the splicing members 54 may be described as defining a channel 32 that faces the low-pressure side 14 of the pressure panel assembly 10. That is, the surface or surfaces of the splicing members 54 facing the low-pressure side 14 may not be contained within a single plane. In particular, the splicing members 54 comprise surfaces that face the low-pressure side 14 and that mate with the corresponding two laterally adjacent panels 50, and when the panels 50 are concave toward the high-pressure side 12 of the pressure panel assembly 10, the splicing members 54 necessarily define a channel 32 that faces the low-pressure side 14 to mate with the panels 50. In examples where the panels 50 comprise planar regions 40, the surfaces of the splicing members 54 to which the planar regions 40 are welded also are planar.

By defining a channel 32 that faces the low-pressure side 14 of the pressure panel assembly 10, when the air pressure is greater on the high-pressure side 12 of the pressure panel assembly 10, the radii in the channel 32 will tend to close, as opposed to open. Accordingly, when the splicing members 54 have a laminar construction, such as from fiber-reinforced thermoplastic plies, interlaminar stresses are compressive rather than tensile, resulting in a more robust structure.

In some examples, such as in example pressure panel assemblies 300 and 600 of FIGS. 3 and 6, each splicing member 54 is welded to the high-pressure side 12 of the corresponding two laterally adjacent panels 50, and each beam 56 is joined directly to a corresponding splicing member 54.

In other examples, such as in the example pressure panel assemblies 400 and 500 of FIGS. 4 and 5, each splicing member 54 is welded to the low-pressure side 14 of the corresponding two laterally adjacent panels 50, and each beam 56 is joined directly to the high-pressure side 12 of the corresponding two laterally adjacent panels 50. In such examples, when the air pressure is greater on the high-pressure side 12 of the pressure panel assembly 10, the panels 50 push against the splicing members 54, thereby compressing the welds 52 between the panels 50 and the splicing members 54.

In some examples, such as in the example of pressure panel assemblies 500 and 600 of FIGS. 5 and 6, the splicing members 54 may be described as being V-shaped.

Additionally or alternatively, in some examples, a splicing member 54 may comprise a first leg 34 that is welded to the first panel 16 and a second leg 36 that is welded to the second panel 18, with the first leg 34 being non-planar with the second leg 36. Such welds 52 may be described as forming lap joints. In some examples, the first leg 34 and the second leg 36 are planar, and the corresponding panels 50 comprise planar regions 40 that are welded to the first leg 34 and to the second leg 36. In some examples, such as in example pressure panel assemblies 300 and 400 of FIGS. 3 and 4, the splicing member 54 further comprises a base 42 between the first leg 34 and the second leg 36, with a corresponding beam 56 being joined directly to the base 42. In some such examples, as in the pressure panel assemblies 300 and 400 of FIGS. 3 and 4, the base 42 is planar and is joined directly to a planar surface of the corresponding beam 56.

As in the example pressure panel assemblies 300 and 400 of FIGS. 3 and 4, some beams 56 comprise a base flange or flanges 62 having a width 64, and a pair of laterally adjacent panels 50 are spaced laterally apart from each other by greater than the width 64. That is, in some examples of pressure panel assemblies 10, two laterally adjacent panels 50 are spaced apart by a gap 66, with the gap 66 being greater than or equal to the width 64 and with the corresponding beam 56 being positioned vertically above the gap 66. Herein, such positional terms as “vertically” are used for convenience, are non-limiting, and refer to the general layout of the example pressure panel assemblies 10 of FIGS. 3-6 as presented on the page.

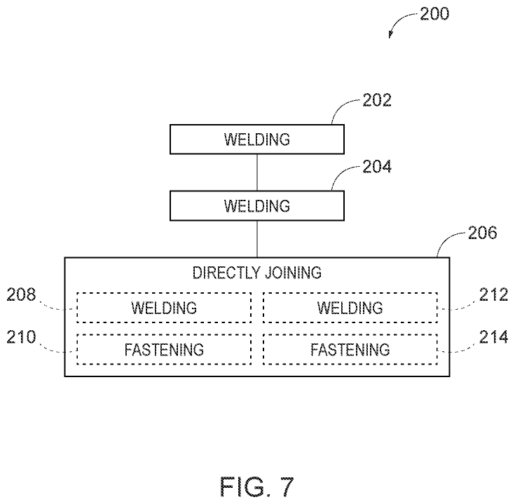

FIG. 7 schematically provides a flowchart that represents illustrative, non-exclusive examples of methods 200 according to the present disclosure. In FIG. 7, some steps are illustrated in dashed boxes indicating that such steps may be optional or may correspond to an optional version of a method 200. That said, not all methods according to the present disclosure are required to include the steps illustrated in solid boxes. The methods and steps illustrated in FIG. 7 are not limiting and other methods and steps are within the scope of the present disclosure, including methods having greater than or fewer than the number of steps illustrated, as understood from the discussions herein.

Methods 200 refer to methods of assembling a pressure panel assembly 10 according to the present disclosure. As schematically presented in FIG. 7, methods 200 comprise at least welding 202 a first panel 16 to a splicing member 54 along a longitudinal panel length 20 of the first panel 16; welding 204 a second panel 18 to the splicing member 54 along a longitudinal panel length 20 of the second panel 18; and directly joining 206 a beam 56 to (i) the splicing member 54 along the longitudinal panel length 20 on the high-pressure side 12 of the splicing member 54 or (ii) to the first panel 16 and to the second panel 18 along the longitudinal panel length 20 on the high-pressure side 12 of the first panel 16 and of the second panel 18. Welding 202 and welding 204 collectively may be described as welding two laterally adjacent panels 50 to a corresponding splicing member 54 along the longitudinal panel length 20 of the panels 50. Examples of welding techniques that may be used include (but are not limited to) induction welding, resistance welding, conduction welding, ultrasonic welding, and film joining.

In some methods 200, the directly joining 206 comprises welding 208 the beam 56 to the high-pressure side 12 of the splicing member 54, as in example pressure panel assemblies 300, 400, and 600 of FIGS. 3, 4, and 6. In some methods 200, the directly joining 206 additionally or alternatively comprises fastening 210 the beam 56 to the high-pressure side 12 of the splicing member 54 with a plurality of fasteners 26, as in example pressure panel assemblies 300, 400, and 600 of FIGS. 3, 4, and 6.

In other methods 200, the directly joining 206 comprises welding 212 the beam 56 to the high-pressure side 12 of the first panel 16 and of the second panel 18, as in example pressure panel assembly 500 of FIG. 5. In some methods, the directly joining 206 additionally or alternatively comprises fastening 214 the beam 56 to the high-pressure side 12 of the first panel 16 and of the second panel 18 with a plurality of fasteners 26, as in example pressure panel assembly 500 of FIG. 5.

Illustrative, non-exclusive examples of inventive subject matter according to the present disclosure are described in the following enumerated paragraphs:

A. A pressure panel assembly (10) having a high-pressure side (12) and a low-pressure side (14) opposite the high-pressure side (12), the pressure panel assembly (10) comprising:

panels (50) comprising at least a first panel (16) and a second panel (18) positioned laterally adjacent to the first panel (16), wherein the first panel (16) and the second panel (18) each have a longitudinal panel length (20);

one or more splicing members (54) comprising at least a first splicing member (22) welded to the first panel (16) and to the second panel (18) along the longitudinal panel length (20) of the first panel (16) and the second panel (18); and one or more beams (56) comprising at least a first beam (24) joined directly to the first splicing member (22) or joined directly to the first panel (16) and to the second panel (18), and extending along the longitudinal panel length (20) on the high-pressure side (12) of the first splicing member (22) or on the high-pressure side (12) of the first panel (16) and of the second panel (18).

A1. The pressure panel assembly (10) of paragraph A, wherein the panels (50) and the one or more splicing members (54) are constructed of a thermoplastic material, optionally a fiber reinforced thermoplastic material.

A2. The pressure panel assembly (10) of any of paragraphs A-A1, wherein the one or more beams (56) and the one or more splicing members (54) are constructed of a thermoplastic material, optionally a fiber reinforced thermoplastic material, and wherein the first beam (24) is welded to the first splicing member (22) along the longitudinal panel length (20).

A3. The pressure panel assembly (10) of any of paragraphs A-A1, wherein the one or more beams (56) and the panels (50) are constructed of a thermoplastic material, and wherein the first beam (24) is welded to the first panel (16) and to the second panel (18) along the longitudinal panel length (20).

A4. The pressure panel assembly (10) of any of paragraphs A-A1, wherein the one or more beams (56) are constructed of a metallic material, and wherein the first beam (24) is fastened to the first splicing member (22) along the longitudinal panel length (20) with a plurality of fasteners (26).

A5. The pressure panel assembly (10) of any of paragraphs A-A1, wherein the one or more beams (56) are constructed of a metallic material, and wherein the first beam (24) is fastened to the first panel (16), to the second panel (18), and to the first splicing member (22) along the longitudinal panel length (20) with a plurality of fasteners (26).

A5.1. The pressure panel assembly (10) of paragraph A5, wherein the first panel (16) and the second panel (18) are positioned and compressed between the first splicing member (22) and the first beam (24).

A5.2. The pressure panel assembly (10) of paragraph A5, wherein the first beam (24) is fastened to the first panel (16), to the second panel (18), and to the first splicing member (22) along the longitudinal panel length (20) with the plurality of fasteners (26), and wherein the first splicing member (22) is positioned and compressed between the first beam (24) and the first panel (16) and between the first beam (24) and the second panel (18).

A5.3. The pressure panel assembly (10) of any of paragraphs A5-A5.2, wherein the first beam (24) is fastened to the first panel (16) and to the first splicing member (22) utilizing a first single row (28) of the fasteners (26), and wherein the first beam (24) is fastened to the second panel (18) and to the first splicing member (22) utilizing a second single row (30) of the fasteners (26).

A6. The pressure panel assembly (10) of any of paragraphs A-A5.3, wherein the pressure panel assembly (10) is free of fay seals between the one or more splicing members (54) and the panels (50).

A7. The pressure panel assembly (10) of any paragraphs A-A6 except for paragraphs A5-A5.3, wherein the pressure panel assembly (10) is free of fasteners that couple together the one or more splicing members (54) and the panels (50)

A8. The pressure panel assembly (10) of any of paragraphs A-A7, wherein the panels (50) each have a cross-sectional shape that is generally uniform along the longitudinal panel length (20), and wherein the cross-sectional shape is concave toward the high-pressure side (12).

A8.1. The pressure panel assembly (10) of paragraph A8, wherein the cross-sectional shape of the panels (50) is substantially catenary.

A9. The pressure panel assembly (10) of any of paragraphs A-A8.1, wherein the one or more splicing members (54) define a channel (32) that faces the low-pressure side (14).

A9.1. The pressure panel assembly (10) of paragraph A9, wherein the first splicing member (22) is welded to the high-pressure side (12) of the first panel (16) and the second panel (18).

A9.1.1. The pressure panel assembly (10) of paragraph A9.1, wherein the first beam (24) is joined directly to the first splicing member (22).

A9.2. The pressure panel assembly (10) of paragraph A9, wherein the first splicing member (22) is welded to the low-pressure side (14) of the first panel (16) and the second panel (18).

A9.2.1. The pressure panel assembly (10) of paragraph A9.2, wherein the first beam (24) is joined directly to the first panel (16) and to the second panel (18).

A9.3. The pressure panel assembly (10) of any of paragraphs A9-A9.2.1, wherein the first splicing member (22) is generally V-shaped.

A9.4. The pressure panel assembly (10) of any of paragraphs A9-A9.3, wherein the first splicing member (22) comprises a first leg (34) welded to the first panel (16) and a second leg (36) welded to the second panel (18), and wherein the first leg (34) is non-planar with the second leg (36).

A9.4.1. The pressure panel assembly (10) of paragraph A9.4, wherein each of the first leg (34) and the second leg (36) is planar, wherein the first panel (16) comprises a first panel planar region (40) welded to the first leg (34), and wherein the second panel (18) comprises a second panel planar region (40) welded to the second leg (36).

A9.4.2. The pressure panel assembly (10) of any of paragraphs A9.4-A9.4.1, wherein the first splicing member (22) further comprises a base (42) between the first leg (34) and the second leg (36), and wherein the first beam (24) is joined directly to the base (42).

A9.4.2.1. The pressure panel assembly (10) of paragraph A9.4.2, wherein the base (42) is planar.

A10. The pressure panel assembly (10) of any of paragraphs A-A9.4.2.1, wherein each of the one or more beams (56) comprises a base flange (62) having a width (64) that is transverse to the longitudinal panel length (20), and wherein the first panel (16) and the second panel (18) are spaced laterally apart by greater than the width (64).

A11. The pressure panel assembly (10) of any of paragraphs A-A10, wherein the second panel (18) is spaced laterally apart from the first panel (16) by a gap (66), and wherein the first beam (24) is positioned vertically above the gap (66).

A11.1. The pressure panel assembly (10) of paragraph A11 when depending from paragraph A10, wherein the gap (66) is greater than or equal to the width (64).

A12. The pressure panel assembly (10) of any of paragraphs A-A11.1,

wherein the panels (50) further comprise a third panel (44) positioned laterally adjacent to the second panel (18) opposite the first panel (16), wherein the third panel (44) has the longitudinal panel length (20);

wherein the one or more splicing members (54) further comprise a second splicing member (46) welded to the second panel (18) and to the third panel (44) along the longitudinal panel length (20) of the second panel (18) and the third panel (44); and

wherein the one or more beams (56) further comprise a second beam (48) joined directly to the second splicing member (46) or joined directly to the second panel (18) and to the third panel (44), and extending along the longitudinal panel length (20) on the high-pressure side (12) of the second splicing member (46) or on the high-pressure side (12) of the second panel (18) and of the third panel (44).

A12.1. The pressure panel assembly (10) of paragraph A12, further comprising the subject matter of any of paragraphs A1-A11, but with respect to the second panel (18), the third panel (44), the second splicing member (46), and the second beam (48) in place of the first panel (16), the second panel (18), the first splicing member (22), and the first beam (24), respectively.

A13. Use of the pressure panel assembly (10) of any of paragraphs A-A12.1 as a pressure deck of an aircraft (100).

B. An aircraft (100) comprising:

a fuselage (102) with a pressurized compartment (104); and

the pressure panel assembly (10) of any of paragraphs A-A12.1 supported by the fuselage (102), wherein the high-pressure side (12) faces the pressurized compartment (104) and the low-pressure side (14) faces away from the pressurized compartment (104).

B1. The aircraft (100) of paragraph B, further comprising:

a wing assembly (106) comprising wing outboard sections (108) and a wing center section (110) between the wing outboard sections (108), wherein the wing assembly (106) is supported by the fuselage (102), wherein the pressure panel assembly (10) is coupled to the wing center section (110), and wherein the low-pressure side (14) faces a wheel well (112) of the aircraft (100).

C. A method (200) of assembling the pressure panel assembly (10) of any of paragraphs A-A12.1, the method (200) comprising:

welding (202) the first panel (16) to the first splicing member (22) along the longitudinal panel length (20);

welding (204) the second panel (18) to the first splicing member (22) along the longitudinal panel length (20); and

directly joining (206) the first beam (24) to (i) the first splicing member (22) along the longitudinal panel length (20) on the high-pressure side (12) of the first splicing member (22) or (ii) to the first panel (16) and to the second panel (18) along the longitudinal panel length (20) on the high-pressure side (12) of the first panel (16) and of the second panel (18).

C1. The method (200) of paragraph C, wherein the directly joining (206) comprises welding (208) the first beam (24) to the high-pressure side (12) of the first splicing member (22).

C2. The method (200) of any of paragraphs C-C1, wherein the directly joining (206) comprises fastening (210) the first beam (24) to the high-pressure side (12) of the first splicing member (22) with a/the plurality of fasteners (26).

C3. The method (200) of paragraph C, wherein the directly joining (206) comprises welding (212) the first beam (24) to the high-pressure side (12) of the first panel (16) and of the second panel (18).

C4. The method (200) of paragraph C or C3, wherein the directly joining (206) comprises fastening (214) the first beam (24) to the high-pressure side (12) of the first panel (16) and of the second panel (18) with a/the plurality of fasteners (26).

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A pressure panel assembly having a high-pressure side and a low-pressure side (14) opposite the high-pressure side, the pressure panel assembly comprising:
panels comprising at least a first panel and a second panel positioned laterally adjacent to the first panel, wherein the first panel and the second panel each have a longitudinal panel length;
one or more splicing members comprising at least a first splicing member welded to the first panel and to the second panel along the longitudinal panel length of the first panel and the second panel; and
one or more beams comprising at least a first beam comprising a base flange joined directly to the first splicing member along the longitudinal panel length on the high-pressure side of the first splicing member, wherein the base flange has a width transverse to the longitudinal panel length;
wherein the first panel and the second panel are spaced laterally apart by greater than the width.

2. The pressure panel assembly of claim 1, wherein the panels and the one or more splicing members are constructed of a thermoplastic material.

3. The pressure panel assembly of claim 2, wherein the one or more beams are constructed of a thermoplastic material, and wherein the first beam is welded to the first splicing member along the longitudinal panel length.

4. The pressure panel assembly of claim 2, wherein the one or more beams are constructed of a metallic material, and wherein the first beam is fastened to the first splicing member along the longitudinal panel length with a plurality of fasteners.

5. The pressure panel assembly of claim 1, wherein the pressure panel assembly is free of fay seals between the one or more splicing members and the panels.

6. The pressure panel assembly of claim 1, wherein the pressure panel assembly is free of fasteners that couple together the one or more splicing members and the panels.

7. The pressure panel assembly of claim 1, wherein the panels each have a cross-sectional shape that is generally uniform along the longitudinal panel length, and wherein the cross-sectional shape is concave toward the high-pressure side.

8. The pressure panel assembly of claim 7, wherein the cross-sectional shape of the panels is substantially catenary.

9. The pressure panel assembly of claim 1, wherein the one or more splicing members (54) defines a channel that faces the low-pressure side.

10. The pressure panel assembly of claim 9, wherein the first splicing member is welded to the high-pressure side of the first panel and the second panel.

11. The pressure panel assembly of claim 9, wherein the first splicing member is welded to the low-pressure side of the first panel and the second panel.

12. The pressure panel assembly of claim 9, wherein the first splicing member is generally V-shaped.

13. The pressure panel assembly of claim 9, wherein the first splicing member comprises a first leg welded to the first panel and a second leg welded to the second panel (18), and wherein the first leg is non-planar with the second leg.

14. The pressure panel assembly of claim 13, wherein each of the first leg and the second leg is planar, wherein the first panel comprises a first panel planar region welded to the first leg, and wherein the second panel comprises a second panel planar region welded to the second leg.

15. The pressure panel assembly of claim 14, wherein the first splicing member further comprises a base between the first leg and the second leg, and wherein the first beam is joined directly to the base.

16. The pressure panel assembly of claim 1, wherein the second panel is spaced laterally apart from the first panel by a gap, wherein the first beam is positioned vertically above the gap, and wherein the gap is greater than or equal to the width.

17. The pressure panel assembly of claim 1,
wherein the panels further comprise a third panel positioned laterally adjacent to the second panel opposite the first panel, wherein the third panel has the longitudinal panel length;
wherein the one or more splicing members further comprise a second splicing member welded to the second panel and to the third panel along the longitudinal panel length of the second panel and the third panel; and
wherein the one or more beams further comprise a second beam joined directly to the second splicing member along the longitudinal panel length on the high-pressure side of the second splicing member.

18. An aircraft comprising:
a fuselage with a pressurized compartment; and
the pressure panel assembly of claim 1 supported by the fuselage, wherein the high-pressure side faces the pressurized compartment and the low-pressure side faces away from the pressurized compartment.

19. The aircraft of claim 18, further comprising:
a wing assembly comprising wing outboard sections and a wing center section between the wing outboard sections, wherein the wing assembly is supported by the fuselage, wherein the pressure panel assembly is coupled to the wing center section, and wherein the low-pressure side faces a wheel well of the aircraft.

20. A method of assembling the pressure panel assembly of claim 1, the method comprising:
welding the first panel to the first splicing member along the longitudinal panel length;
welding the second panel to the first splicing member along the longitudinal panel length; and
directly joining the first beam to the first splicing member along the longitudinal panel length on the high-pressure side of the first splicing member.
